(19) United States
(12) Patent Application Publication
(10) Pub. No.: US 2015/0090912 A1
(43) Pub. Date: Apr. 2, 2015

(54) PRESSURE CONTROL VALVE

(71) Applicant: PIERBURG GMBH, NEUSS (DE)

(72) Inventors: WERNER BUSE, KAARST (DE); FRANZ-JOSEF SCHNELKER, NEUSS (DE); ROLF DOHRMANN, KAARST (DE)

(21) Appl. No.: 14/564,102

(22) Filed: Dec. 9, 2014

Related U.S. Application Data
(63) Continuation of application No. 13/130,054, filed on May 19, 2011.

(30) Foreign Application Priority Data
Dec. 9, 2008 (DE) 10 2008 060 889.0

(51) Int. Cl. F16K 31/06; F16K 1/42

(52) U.S. Cl. CPC F16K 31/0658; F16K 31/0693; F16K 1/42
USPC 251/129.07; 251/129.15; 251/129.18

(57) ABSTRACT

A pressure control valve includes a housing with a lower part and an upper part. The housing includes a coil wound on a coil carrier, an armature configured to be axially displaceable within a bearing, a core, a flux guiding device, a connection bore, and a connector comprising a valve seat for the armature. The connector and the connection bore are disposed in the lower part of the housing. The upper part of the housing is arranged in a force-locked or a form-fitting manner. A bearing bushing for the armature is provided in a portion of the connector directed towards the core. A stop bushing for the armature is provided in an opposite portion of the connector.

### CROSS REFERENCE TO PRIOR APPLICATIONS

This application is a continuation of application Ser. No. 13/130,054, filed on May 19, 2011, which is a U.S National Phase application under 35 U.S.C. §371 of International Application No. PCT/EP2009/062995, filed on Oct. 7, 2009 and which claims benefit to German Patent Application No. 10 2008 060 889.0, filed on Dec. 9, 2008. The International Application was published in German on Jun. 17, 2010 as WO 2010/066485 A1 under PCT Article 21(2).

### FIELD

The present invention relates to a pressure control valve having a housing, the housing comprising a coil wound on a coil carrier, an armature axially displaceable within a bearing, a core, a flux guiding device, a connection bore and a connector, the connector including a valve seat for the armature.

### BACKGROUND

Pressure control valves of the above type are, for example, used in hydraulic actuators, in control devices for automatic transmissions of automobiles, or also in combination with a pressure- or throughput-controlled motor oil pump. Such valves can be on/off valves or also so-called modulator valves designed for a stepless control of a throughput. An example is an on/off control valve as described in DE 197 16 185 A1. In this valve, an electromagnetically driven armature is provided for cooperation with a valve seat in order to establish a fluidic connection between a connection opening and an outflow bore. The armature cooperates with pressure springs and the electromagnetic drive for establishing a sealed closure in the off position. For safeguarding this effect, high demands are posed on the electromagnetic drive and the manufacturing accuracy of the pressure control valve, which naturally leads to considerable expenditure for manufacture and assembly.

### SUMMARY

An aspect of the present invention is to provide a pressure control valve providing functional accuracy while requiring a minimum expenditure for manufacture and assembly.

In an embodiment, the present invention provides a pressure control valve which includes a housing with a lower part and an upper part. The housing includes a coil wound on a coil carrier, an armature configured to be axially displaceable within a bearing, a core, a flux guiding device, a connection bore, and a connector comprising a valve seat for the armature. The connector and the connection bore are disposed in the lower part of the housing. The upper part of the housing is arranged in a force-locked or a form-fitting manner. A bearing bushing for the armature is provided in a portion of the connector directed towards the core. A stop bushing for the armature is provided in an opposite portion of the connector. The pressure control valve can therefore be manufactured in an inexpensive manner while providing tolerance accuracy and manufacturing accuracy.

### BRIEF DESCRIPTION OF THE DRAWINGS

The present invention is described in greater detail below on the basis of embodiments and of the drawing in which:

FIG. 1 shows a sectional view of an embodiment of a pressure control valve.

### DETAILED DESCRIPTION

The lower part comprises a throughgoing bore in which the bearing bushing and the stop bushing can be arranged in a force-locked or form-fitting manner. The lower part can therefore be produced in an inexpensive manner while avoiding alignment inaccuracies between the bearing bushing and the stop bushing in a simple manner.

The bearing bushing can be arranged in the lower part at a position set back relative to the connection bore so as to realize a high throughput of the pressurizing medium via the connection bore also with a small armature stroke. In this arrangement, the penetration depth of the stop bushing into the lower part can be adjustable so that the length of stroke of the armature is adjustable. This can be provided, for example, by press-fitting the stop bushing into the lower part and comprises a milled edge, knurl or the like, so that the adjusting of the stop bushing can be carried out conveniently and accurately.

For obtaining a good sealing effect, the end of the armature directed toward the lower part can be beveled at an angle α and the end of the stop bushing directed toward the armature can be beveled at an angle β so as to provide a linear contact between the armature and the stop bushing.

The core can, for example, comprise a rod made of a non-magnetizable material, the rod serving as a stopper element for the armature and acting as a spring seat for a spring resiliently supporting the armature relative to the core. The rod can thereby be arranged in the core in an adjustable manner.

To also safeguard an easy movability of the armature, the armature can, for example, be provided with an inner bore for equalization of pressure via the armature. This feature has the additional result that the solenoid drive is allowed to provide a considerably lower force for moving the armature and can be designed in a correspondingly less expensive manner.

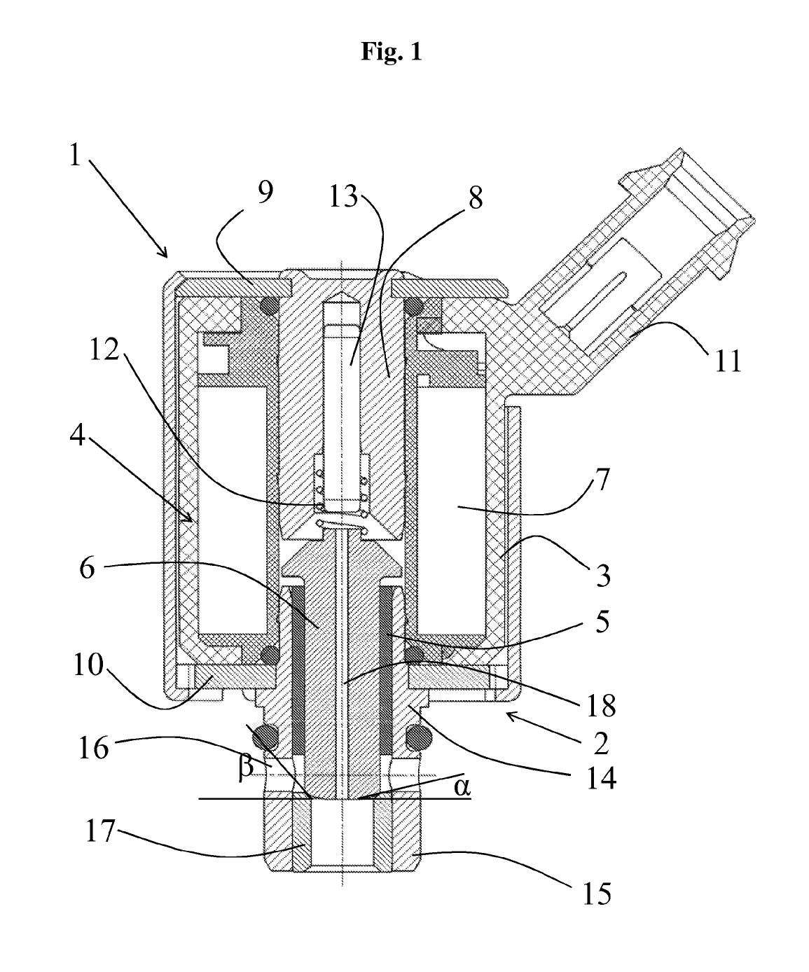

In an embodiment of the present invention as shown in FIG. 1, the control valve 1 of the present invention comprises a housing 2 which is substantially of a two-part design. The upper part 3 comprises an electromagnetic drive unit 4 acting on an armature 6 arranged for axial displacement in a bearing 5. Said electromagnetic drive 4 consists substantially of a coil 7, a core 8 and a flux guiding device composed of a reflux metal sheet 9 and a yoke 10. The housing, which is made of plastic, further comprises a plug connector 11 for controlling the pressure control valve. In the present case, core 8 is snap-fastened in said upper part 3.

The electromagnetic drive 4 is operative to act on the armature 6 which in the present case serves as a valve rod and a valve closure member of an on/off valve. By means of a spring 12, armature 6 is biased relative to core 8 into a closing position. Said spring 12 is guided by a rod 13 which in the assembled state is adjustably arranged in the core and which at the same time serves as a stopping element for armature 6. The armature 6 in turn is movably supported in a bearing bushing 5, herein designed as a sliding bearing, of which at least the sliding surface is made of a non-magnetizable material. The bearing bushing can consist of a magnetizable steel-made carrier sheet and a non-magnetizable sliding layer made, for example, of bronze or Teflon. In this arrangement, the thickness ratio between said steel-made carrier sheet and said sliding layer is about 70:30 for providing optimal running properties for the armature as well as a sufficient magnetic force. The bearing bushing 5 is located in a lower part 14 which is arranged in the upper part 3 of housing 2 in force- or form-locked engagement with upper part 3. The lower part 14 further comprises a connector 15 serving, in the present case, to supply a pressurizing medium, and is formed with a connection bore 16 through which the pressurizing medium can be forwarded. Provided within the connector 15 is a stop bushing 17 forming the valve seat for armature 6. The end of the armature 6 directed toward the lower part 14 is beveled at an angle α, and the end of the stop bushing 17 directed toward the armature 6 is beveled at an angle β. Due to the different angles, the armature 6 can be arranged with linear contact on the stop bushing 17, resulting in a good sealing effect. In the final assembly process, the linear sealing can be safeguarded by a so-called “impacting” effect. The stop bushing 17 is also provided with a knurl, not shown, which makes it possible to precisely adjust the penetration depth of the stop bushing 17 and thus to delimit the stroke length of the armature 6.

To achieve a full-faced flow through the connection bore 16 while the pressurizing medium is flowing from connector 15 to connection bore 16, bearing 5 is arranged in the lower part 15 at a position that is slightly set back relative to the connection bore 16, whereby the free area corresponding to the thickness of the bearing forms a flow zone allowing for the full-faced flow through connection bore 16.

Armature 6 further comprises an inner bore 18 which is effective to equalize the pressure via armature 6. Due to the design of the armature 6 and the fact that the pressure above armature 6 is the same as the pressure below armature 6, the armature 6 itself is pressure-balanced. The electromagnetic drive 4 can therefore be given a simpler and less expensive configuration.

In the non-activated state, armature 6 is pressed by return spring 12 against the valve seat of stop bushing 17, thus shutting off the fluidic connection between connector 15 and connection bore 16.

The illustrated pressure control valve 1 can, for example, be used as a control valve for a controllable mechanical oil pump in which this control valve is provided for controlling the delivery quantity of the oil. If the oil pressure of the oil pump is to be reduced, the electromagnetic drive 4 will be actuated and the armature 6 will thus be moved in the direction toward core 8. The oil can thereby be guided, via the feed passage of connector 15, to the connection bore 16 and, from there, be conveyed in an unpressurized manner into an oil pan, not illustrated. By the configuration shown herein and, for example, by the provision of a lower part 14 accommodating, within an inner bore thereof, the bearing bushing 5 for support of armature 6 as well as the stop bushing 17 with the valve seat for the armature 6, there is provided an easy-running arrangement which can be produced free of tolerance inaccuracies and therefore at low expense. It should thus be evident that such a pressure control valve 1 can be designed not only as an on/off valve but also as a steples sly controllable pressure control valve. In the latter case, it can be contemplated, for example, to perform the opening and respectively the closing of the connection bore 16 by means of a known slider arrangement.

The present invention is not limited to embodiments described herein; reference should be had to the appended claims.

What is claimed is:

1. A pressure control valve comprising a housing with a lower part and an upper part, the housing comprising:
a coil wound on a coil carrier;
an armature configured to be axially displaceable within a bearing;
a core;
a flux guiding device;
a connection bore; and
a connector comprising a valve seat for the armature,
wherein the connector and the connection bore are disposed in the lower part of the housing and the upper part of the housing is arranged in a force-locked or a form-fitting manner, a bearing bushing for the armature being provided in a portion of the connector directed towards the core and a stop bushing for the armature being provided in an opposite portion of the connector.

2. The pressure control valve as recited in claim 1, wherein the lower part includes a throughgoing bore in which the bearing bushing and the stop bushing are arranged in a force-locked or a form-fitting manner.

3. The pressure control valve as recited in claim 1, wherein the bearing bushing is arranged in the lower part of the housing at a position set back relative to the connection bore.

4. The pressure control valve as recited in claim 1, wherein a penetration depth of the stop bushing into the lower part is configured to be adjustable so that a stroke length of the armature is adjustable.

5. The pressure control valve as recited in claim 4, wherein the stop bushing includes a milled edge, a knurl, the stop bushing being press-fitted into the lower part of the housing.

6. The pressure control valve as recited in claim 1, wherein an end of the armature directed toward the lower part is beveled at an angle α, and an end of the stop bushing directed toward the armature is beveled at an angle β so as to provide a linear contact between the armature and the stop bushing.

7. The pressure control valve as recited in claim 1, wherein the core includes a rod comprising a non-magnetizable material, the rod being configured to act as a stopper element for the armature and as a spring guide for a spring to support the armature relaive to the core.

8. The pressure control valve as recited in claim 7, wherein the rod is arranged adjustably in the core.

9. The pressure control valve as recited in claim 1, wherein the armature includes an inner bore.

10. A pressure control valve comprising a housing with a lower part and an upper part, the housing comprising:
a coil wound on a coil carrier;
an armature configured to be axially displaceable within a bearing;
a core;
a flux guiding device;
a connector comprising a valve seat for the armature,
a bearing bushing for the armature arranged only in a portion of the connector directed towards the core, the bearing bushing comprising an inner diameter facing the armature, an outer diameter facing the connector, and a bearing bushing width defined by a distance between the inner diameter of the bearing bushing and the outer diameter of the bearing bushing;
a stop bushing for the armature arranged in a portion of the connector directed away from the core, and
a connection bore, the connection bore being defined by the lower part of the housing and the connector,
wherein,
the connector and the connection bore are disposed in the lower part of the housing,
the lower part of the housing is arranged in a force-locked or a form-fitting manner in the upper part of the housing, and
the bearing bushing is arranged in the lower part of the housing at a set back distance from the connection bore, the set back distance of the bearing bushing from the connection bore thereby defining a free area which is defined by the set back distance and a free area width, the free area width being equal to the bearing bushing width, and the set back distance being less than the free area width.

11. The pressure control valve as recited in claim 10, wherein the lower part includes a throughgoing bore in which the bearing bushing and the stop bushing are arranged in a force-locked or a form-fitting manner.

12. The pressure control valve as recited in claim 10, wherein a penetration depth of the stop bushing into the lower part is configured to be adjustable so that a stroke length of the armature is adjustable.

13. The pressure control valve as recited in claim 13, wherein the stop bushing includes a milled edge, a knurl, the stop bushing being press-fitted into the lower part of the housing.

14. The pressure control valve as recited in claim 10, wherein an end of the armature directed toward the lower part is beveled at an angle α, and an end of the stop bushing directed toward the armature is beveled at an angle β so as to provide a linear contact between the armature and the stop bushing.

15. The pressure control valve as recited in claim 10, wherein the core includes a rod comprising a non-magnetizable material, the rod being configured to act as a stopper element for the armature and as a spring guide for a spring to support the armature relative to the core.

16. The pressure control valve as recited in claim 16, wherein the rod is arranged adjustably in the core.

17. The pressure control valve as recited in claim 10, wherein the armature includes an inner bore.

18. The pressure control valve as recited in claim 10, wherein the connection bore comprises two openings, and the bearing bushing is arranged at the set back position at each of the two openings.
